(19) United States
(12) Patent Application Publication
(10) Pub. No.: US 2008/0030656 A1
(43) Pub. Date: Feb. 7, 2008

(54) TRANSFLECTIVE LC DISPLAY WITH INTERNAL REFLECTOR AND REFLECTIVE POLARIZER

(75) Inventors: Philip E. Watson, Saint Paul, MN (US); Andrew J. Ouderkirk, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/831,995

(22) Filed: Aug. 1, 2007

Related U.S. Application Data
(60) Provisional application No. 60/821,123, filed on Aug. 1, 2006.

(51) Int. Cl. G02F 1/1335

(52) U.S. Cl. 349/96

(57) ABSTRACT

A transflective display having a reflective viewing mode and a transmissive viewing mode is provided. The transflective display includes a liquid crystal (LC) panel having an array of partially reflective pixels. The reflective portions of the array of partially reflective pixels include metal positioned on a viewer side of the LC panel to reflect light back toward the viewer. The display also includes a reflective polarizer, in place of a conventional rear polarizer, positioned behind the LC panel on a side of the LC panel opposite the viewer side. The reflective polarizer is also oriented to reflect ambient light back toward the viewer.

### CROSS-REFERENCE TO RELATED APPLICATION

The present application is based on and claims the benefit of U.S. provisional patent application Ser. No. 60/821,123, filed Aug. 1, 2006.

### FIELD OF THE INVENTION

The present invention relates to display devices, particularly those that utilize a liquid crystal (LC) panel and that can operate in both reflected ambient light and transmitted light originating from a backlight, and related articles and processes.

### DISCUSSION

Microprocessor-based devices that include electronic displays for conveying information to a viewer have become nearly ubiquitous. Mobile phones, handheld computers, personal digital assistants (PDAs), electronic games, MP3 players and other portable music players, car stereos and indicators, public displays, automated teller machines, in-store kiosks, home appliances, computer monitors, and televisions are examples of such devices. Many of the displays provided on such devices are liquid crystal displays (LCDs or LC displays).

Unlike cathode ray tube (CRT) displays, LCDs do not have a phosphorescent image screen that emits light and, thus, require a separate light source for viewing images formed on such displays. For example, a source of light can be located behind the display, which is generally known as a “backlight.” The backlight is situated on the opposite side of the LCD from the viewer, such that light generated by the backlight passes through the LCD to reach the viewer. An LC display using such a backlight can be said to be operating in “transmissive” mode. An alternative source of illumination can be from an external light source, such as ambient room lights or the sun.

Some LC displays are designed to operate in either of two modes: the transmissive mode utilizing a backlight, described above, or a “reflective” mode, utilizing light reflected from an external light source situated on the viewer-side of the LCD. Such LC displays, known as “transflective” displays, commonly possess an LC panel and a partially reflective layer between the LC panel and the backlight. In other cases, the partially reflective layer is disposed inside the LC panel rather than between the LC panel and the backlight. In either case, the partially reflective layer, referred to herein as a “transflector”, transmits a sufficient portion of light from the backlight, while also reflecting a sufficient portion of external light, to permit the display to be viewed in both transmissive mode and reflective mode. An exemplary transflector is Vikuiti™ Transflective Display Film (“TDF”) available from 3M Company. This film includes a reflective polarizer, i.e., a body that reflects light of one polarization state and transmits light of an orthogonal polarization state, formed from a polymeric multilayer optical film. The TDF product also includes a layer of diffuse adhesive and a neutral density coating.

The LC panel component of the LC display commonly includes two substrates and a liquid crystal material disposed between them. The substrates may be fabricated from glass, plastic, or other suitable transparent materials. The substrates are supplied with an array of electrodes that can provide electrical signals to a corresponding array of individual areas known as picture elements (pixels), which collectively define the viewing area of the display and individually define the resolution of the display. Electrical signals provided by the electrodes, typically in conjunction with thin film transistors (TFTs), permit the optics of each pixel to be adjusted, for example to either significantly modify the polarization state of transmitted light, or to allow the light to pass without significant modification to its polarization state. In some cases the electrical signal can switch the liquid crystal from a transmissive state to a scattering state, or provide some other optical change in the pixel. The LC panel typically does not include a highly absorptive color filter situated between the substrates. It may, however, include a weak color filter that absorbs less than 50% of incident light over the visible spectrum.

The liquid crystal material in the LC panel may be nematic, as in the case of a Twisted Nematic (TN), Optically Compensated Bend (OCB), Electrically Controlled Birefringence (ECB), Supertwisted Nematic (STN), or bistable nematic liquid crystal, or other known nematic modes. It may also be a smectic liquid crystal as used in Ferroelectric, Antiferroelectric, Ferrielectric, and other smectic modes. The liquid crystal may also be a cholesteric liquid crystal, a liquid crystal/polymer composite, a polymer-dispersed liquid crystal, or any other type of liquid crystal configuration that may be electrically switched between at least two optically differentiable states.

Usually, LC displays are either monochrome or color. In a monochrome display, each of the pixels in the viewing area can be made to be dark, bright, or an intermediate intensity level, as in a grayscale image. Such intensity modulation is usually used with white light (to yield pixels that are white, black, or gray) but can alternatively be used with light of any other single color such as green, orange, etc. But such intensity modulation cannot produce a range of colors at any arbitrary location on the viewing area. In contrast, “full color” LC displays can produce a range of perceived colors, such as red, green, or blue, at any arbitrary location within the viewing area.

The design of traditional transflective systems often involves compromises between reflective brightness, transmissive brightness, and color generation. Typically, a transflective layer, located either between the transparent substrates of the liquid crystal panel, or between the liquid crystal panel and the backlight, will reflect a fraction of incident light in order to provide illumination from external sources in the reflective mode, and will transmit a different fraction of incident light in order to provide illumination from the backlight in the transmissive mode. The design of the transflector may be tuned such that the transmissive mode or reflective mode is brighter, often at the expense of the other.

### BRIEF SUMMARY

The present application discloses, inter alia, a transflective display having a reflective viewing mode and a transmissive viewing mode. The display includes a liquid crystal (LC) panel positioned forward of a reflective polarizer. The reflective polarizer replaces conventional rear polarizers, functioning with a front polarizer to control absorption/transmission of transmitted or reflected light. The LC panel includes partially reflective pixels having reflective portions and transmissive portions. The reflective portions include a metal layer positioned on a viewer side of the LC panel for reflecting ambient light back toward the viewer. The reflective polarizer is positioned behind at least transmissive portions of a pixel in order to also reflect ambient light back toward the viewer. Together, the partially reflective pixels and the reflective polarizer provide excellent brightness in reflective mode from a very high percentage of the display area.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a schematic side view of a portion of a transflective liquid crystal display having partially reflective pixels in combination with a reflective polarizer; and

FIGS. 2-5 are schematic side views of a portion of a more particular transflective liquid crystal display embodiment.

FIGS. 6 and 7 are schematic side views of laminate film structures.

FIG. 8 is a schematic side view of a portion of a transflective liquid crystal display using one of the laminate structures of FIGS. 6 or 7.

In the figures, like reference numerals designate like elements.

### DETAILED DESCRIPTION OF ILLUSTRATIVE EMBODIMENTS

As discussed above, a “transflective” liquid crystal (LC) display is any direct-view LC display that may be used in both an ambient mode and a backlit mode. Disclosed transflective LC displays utilize a configuration which includes both an internal reflective layer and an external transflective layer to provide very high reflectance in the reflective mode, but also very good brightness in the transmissive mode. The two reflective modes, from the internal reflector and the external transflector, work together to provide excellent brightness from a very high percentage of the display area.

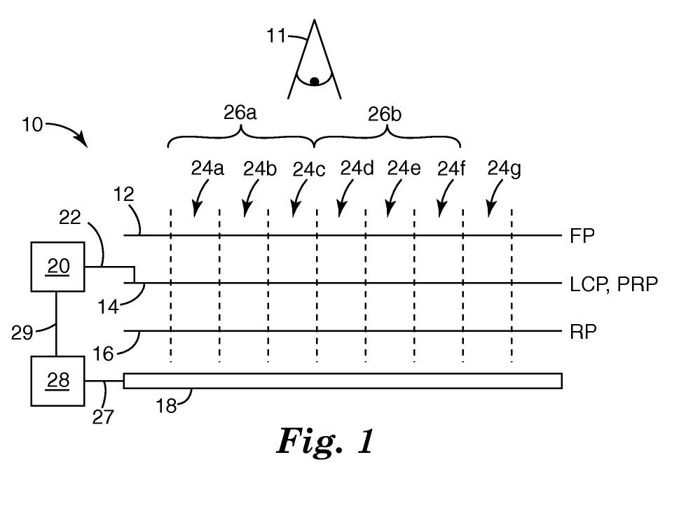

FIG. 1 shows a schematic side view of a portion of a transflective LC display 10 that includes a front polarizer 12, an LC panel 14, a reflective polarizer 16 in place of the conventional rear polarizer, and a backlight 18. A controller 20 is electronically coupled to LC panel 14 via a connection 22 to control the optical state of individual pixels 24a-g of the LC panel, which pixels extend in a repeating pattern or array over an area that defines the overall viewing area of the display. Another controller 26 is electronically coupled to backlight 18 via a connection 28 to control the operation thereof in some, but not necessarily all, LC displays. Further, in some displays, another connection 29 between controllers 20, 26 allows for synchronized operation of the LC panel and the backlight.

Front polarizer 12 can be any known polarizer, but in exemplary embodiments it is an absorptive polarizer (sometimes also referred to as a dichroic polarizer) for ease of viewing and reduced glare for observer 11. Polarizer 12 can be a flexible polymer-based film and can be laminated or otherwise adhered to LC panel 14, for example, using an optically clear adhesive. If polarizer 12 is a linear polarizer, it has a pass axis and a block axis in the plane of the film or layer. Light polarized parallel to the pass axis is transmitted, and light polarized parallel to the block axis (perpendicular to the pass axis) is blocked e.g. by absorption, by the front polarizer 12.

LC panel 14 includes a liquid crystal material sealed between two transparent substrates and an array of electrodes that define a corresponding array of pixels 24a-g. A controller 20 is capable of addressing or controlling each of the pixels individually so as to form a desired image. Depending on whether a given pixel is turned on or off, or at an intermediate state, the LC panel rotates the polarization of light passing therethrough. Similarly, the LC panel may change the polarization state of light from linear to elliptical or to circular, or vice versa. The LC panel may have its front face attached to the front polarizer, and may also include a diffuser film, an antireflection film, an anti-glare surface, or other front-surface treatments.

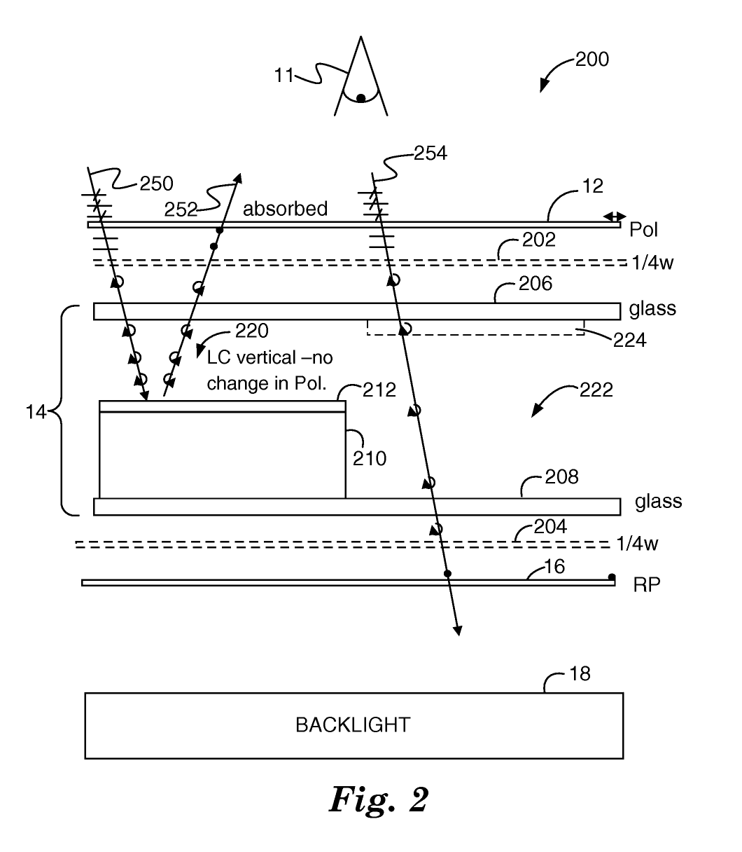

FIG. 2 illustrates a more particular display 200, which is one embodiment of display 10 shown in FIG. 1. Referring now to both of FIGS. 1 and 2, the array of pixels in LC panel 14 are an array of partially reflective pixels (PRP). The partially reflective pixels, which are illustrated in greater detail in FIGS. 2-5 for example, can be configured to include metal positioned on a viewer side (i.e., the side of observer 11) of the LC panel using an internal reflective layer 212 (not shown in FIG. 1). The internal reflective layer 212 may be aluminum, silver, indium or any other metal reflective layer providing broad band reflection, and covers some percentage of the pixel area as viewed from the direction of observer 11. In exemplary displays, the reflective portion 220 of each pixel 24, having internal (to the LC panel 14) reflective layer 212 in front of the opaque pixel portions 210, comprises between about 15% and about 75% of the total pixel, while the transmissive portion 222 of the pixel comprises substantially the remainder of the pixel area. In particular, in exemplary embodiments reflective portion 220 covers area that would otherwise be black masked to cover the TFT, storage capacitor, or pixel-edge area. The LC layer thickness (e.g., the thickness of the LC material between substrates 206 and 208 shown in FIG. 2) where the internal reflector 212 is located is typically thinner than (perhaps half as thick as) in the transmissive area 222 of the pixel.

Display 10 can be a monochrome display or a color display. For color, the display can use field sequential color techniques, diffractive color separation, color filters, or a combination of these effects for color generation. Color filters 224 as shown in FIG. 2, if any, can be only over the transmissive portion 224 of each pixel. However, in other configurations, the color filters can cover the entire pixel area. For illustrative purposes, color filters are omitted from other figures.

Backlight 18 can be any of multiple different backlight types, for example including either direct lit or edge lit backlight designs. Backlight 18 can utilize fluorescent bulbs, light emitting diodes (LEDs), or electroluminescent lighting technologies. In some displays, backlight 18 is a field sequential color backlight under the control of controller 28. In these displays, color filters 224 will not typically be necessary. In other displays, backlight 18 can be a diffractive backlight, in which case color filters would typically, but not necessarily, be used. Although shown only schematically, backlight 18 also typically includes conventional components such as light guides, light enhancement films, lenses, and other components to provide substantially uniform and efficient illumination over the viewing area of the display.

Reflective polarizer 16 is an external transflector in that it is external to and positioned behind the LC panel 14 and its partially reflective internal layer 212, typically between LC panel 14 and backlight 18. In exemplary embodiments, reflective polarizer 16 covers the entire area of the pixel, and particularly covers the transmissive area 222 of the pixel. Reflective polarizer 16 can be a linear reflective polarizer, for example such a Vikuiti™ RDF-C or TDF film (3M Company, St. Paul, Minn.). Another type of reflective polarizer which can be used is a DRPF polarizer as described in U.S. Pat. No. 6,111,696. Reflective polarizer 16 can also be a wire grid reflective polarizer or a cholesteric reflective polarizer, for example. Reflective polarizer 16 can be, but is not necessarily, of polymeric multilayer design as described in U.S. Pat. No. 5,882,774 (Jonza et al.), or U.S. Application Publication Nos. 2002/0190406 (Merrill et al.), 2002/0180107 (Jackson et al.), 2004/0099992 (Merrill et al.) and 2004/0099993 (Jackson et al.). As such, the polarizer 16 has a pass axis and a block axis in the plane of the polarizer, where light polarized parallel to the pass axis is substantially transmitted and light polarized parallel to the block axis is substantially reflected by the polarizer 16. Absorption in the polarizer 16 is typically negligible, particularly over visible wavelengths. The pass axis of the back polarizer 16 can have any desired orientation with respect to the pass axis of front polarizer 12, but for purposes of the present description we will assume it is perpendicular thereto. In such case, display 10 is an inverting-type transflector, because pixels 24 whose state (determined by controller 20) makes them bright in reflective viewing mode makes them dark in transmissive viewing mode, and pixels 24 whose state makes them dark in reflective viewing mode makes them bright in transmissive viewing mode.

In this regard, transflective displays generally fall under two classes of operation: inverting and non-inverting. Non-inverting displays provide the same image in both the reflective and transmissive operating modes, because in both cases, any light that exits the display travels from the transflector to the back polarizer (which defines the light's polarization state), through the LC panel, and exits through the front polarizer. External light incident on the display passes through the front polarizer, through the LC panel, through the back polarizer, reflects from the transflector, passes back through the back polarizer and the LC panel, and exits through the front polarizer. Light from the backlight passes through the transflector, through the back polarizer, through the LC panel, and exits through the front polarizer. Since the two operating modes provide similar images (although the reflective-mode image will be monochrome while the backlit image may be colored), then the light exiting the system from the reflective and transmissive modes will work together to provide a brighter overall image.

As described, reflective polarizer 16 serves as the back polarizer of the LC display. The reflective polarizer may, for example, be a sheet of Vikuiti™ RDF-C film (3M Company, St. Paul, Minn.) laminated in place of a conventional absorptive back polarizer in the display. The RDF-C film includes a polymeric multilayer reflective polarizer and a layer of light-diffusing adhesive. In this case, external light incident on the display passes through the front polarizer, then through the LC panel, and impinges on the reflective polarizer. At this point, one polarization state (state “1”) is reflected, and passes back through the LC panel and the front polarizer. But light of an orthogonal polarization state (state “2”) is transmitted by the reflective polarizer and is absorbed or otherwise lost in the vicinity of the backlight. For light originating from the backlight, polarization state 2 is transmitted through the reflective polarizer, through the LC panel, and through the front polarizer, while polarization state 1 is reflected back into the backlight and lost. Thus, the reflective operating mode introduces polarization state 1 into the LC panel, while the transmissive operating mode introduces polarization state 2 into the LC panel, and the two images will therefore be reversed. Consequently, the transmissive mode image appears as a photo-negative of the reflective mode image, except that the transmissive mode image may contain bright colors, while the reflective mode image may be monochrome.

In the case of inverting displays, it is also possible to modify the image output electronically using controller 20 in order to correct for the optical inversion. Controller 20 may for example include an electronic inversion algorithm that is activated or not depending upon whether the backlight 18 is energized, i.e., depending on whether the display 10 is in reflective mode or transmissive mode. Such an algorithm can electronically modify the control signals to the individual pixels to electronically invert the image in the transmissive mode when the backlight is activated, so that the image appears with the same foreground/background scheme as in the reflective mode.

If desired, a polarization-preserving light diffusing layer can also be included as part of the reflective polarizer 16 to enhance the appearance of the image. The transflector 16 is situated between the LC panel 14 and the backlight 18 such that it can reflect light from external sources such as room lights or the sun.

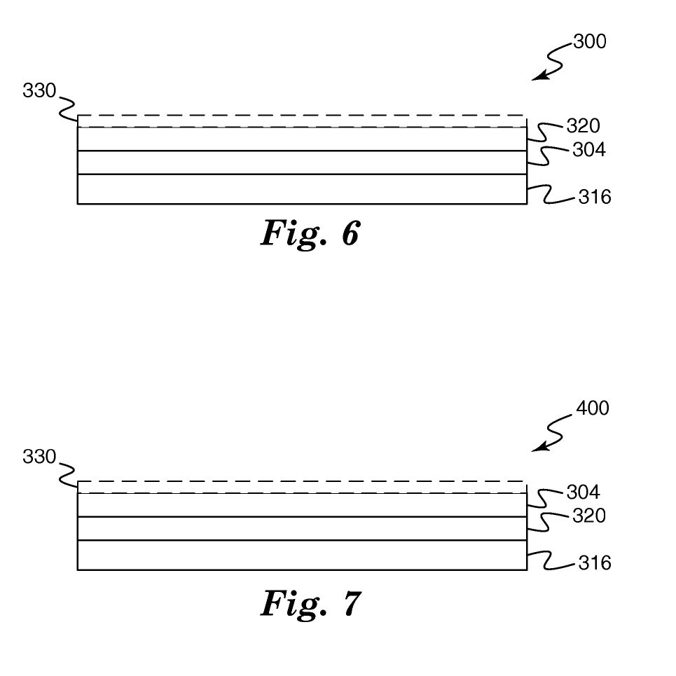

Referring next to FIGS. 6 and 7, shown are laminate structures 300 and 400 having a linear reflective polarizer 316, a one-quarter wave film (QWF) 304, and a non-depolarizing, or polarization-preserving diffuser 320. These laminate structures can be produced and sold for use in place of reflective polarizer 16 and QWF 204 shown in displays 10 and 200. The film in laminate structures 300 and 400 can be attached together using a UV curable or pressure-sensitive adhesive 320. These laminate structures can also optionally include a transparent adhesive 330 for use in attaching the laminates to glass 208 or other substrates. Linear polarizer 316 can be, for example, RDF or TDF reflective polarizers of the type described in U.S. Pat. No. 6,124,971 to Ouderkirk et al., which is herein incorporated by reference. The linear polarizer 316 can also optionally include a neutral density coating. In some laminate structure embodiments, the quarter wave film provides quarter wave retardation for visible wavelengths and particularly for red, green and blue wavelengths.

In some display or laminate embodiments, in the reflective polarizers, e.g., linear reflective polarizers such as those described in the '971 patent, a diffusing element reduces the specular reflectivity of reflective polarizing element for the reflected polarization without substantially increasing the reflectivity of the reflective polarizing element or lessening the polarizing efficiency for the transmitted polarization. In other words, the diffusing element can be polarization preserving in that it does not randomize the polarization of the light that is either reflected or transmitted by the reflective polarizing element. Ideally, the diffusing element has a high degree of forward scattering of light, i.e., low reflectivity. This is beneficial for preserving maximum selectivity of polarized light for the reflective polarizing element. Varying levels of diffusion can be used depending on the application, ranging from almost no diffusion (specular) to a very heavy amount of diffusion (lambertian). The diffusing element can either be a separate optical element or be directly applied or laminated to the surface of the reflective polarizing element. In some displays, an elliptical diffuser that scatters light asymmetrically provides good performance. In addition, diffusing adhesives can be used as the diffusing element.

In some example embodiments, the reflective polarizers can also include a light absorbing film or neutral density coating to optimize viewability under ambient lighting conditions while not significantly affecting display appearance under backlighting conditions. The light absorbing film may be a dichroic polarizer. The light absorbing film absorbs some of diffusely reflected light out of the backlight, thus increasing the effective absorption of the backlight lighting and increasing display contrast under ambient lighting conditions. In some embodiments, the overall effect under ambient lighting conditions is of diffusely illuminated characters against a dark background, and dark characters against a diffuse white background when backlit.

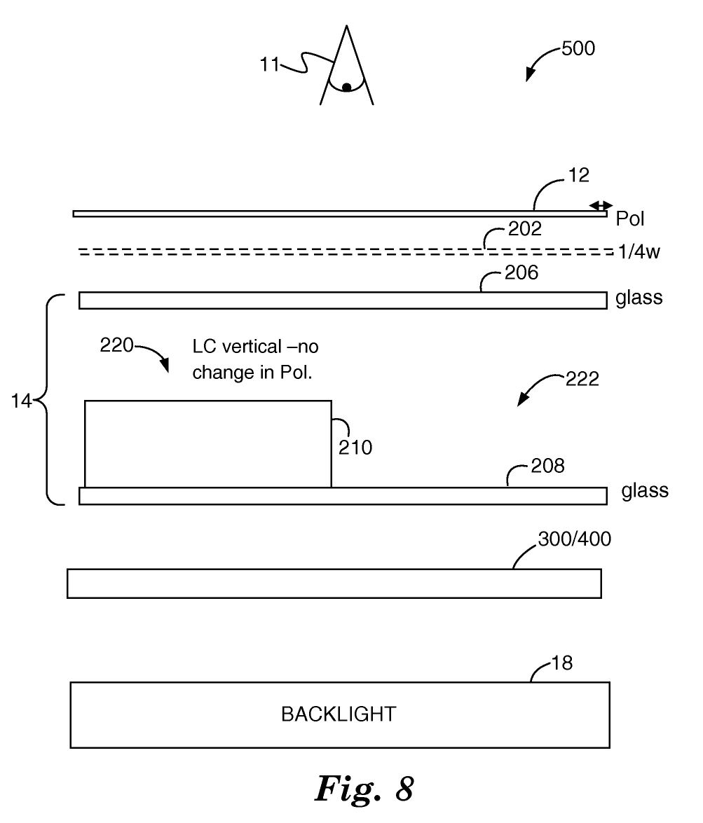

Referring briefly to FIG. 8, shown is a display 500 which utilizes one of laminates 300, 400 in place of the reflective polarizer 16 and the rear QWF 204. Display 500 is substantially the same as display 200 with this exception, and with the exception of it not including reflective pixels (e.g., internal reflective layer 212 from FIG. 2).

Referring now more specifically to FIGS. 2-5, shown are features of the display 200 configuration that effectively uses both types of transflectors (212 and 16) in tandem. Internal reflector 212 allows for usage of up to 90% of the pixel area for image portrayal, but since the display also includes a reflective polarizer-based transflector 16 external to the LC panel 14 the active area is made useful for both transmissive and reflective images. In this way, in an exemplary embodiment, up to about 90% of the active area is used for the reflective image (at two different efficiencies), and about 70% is still used for the transmissive area.

Display 200 includes the LC panel 14 with LC between glass plates or other substrates 206 and 208. In the reflective portion 220 of each pixel, reflective layer 212 is positioned on top of the opaque pixel portions 210, while in the transmissive portion 222 of each pixel, the LC material is thicker and not covered with the reflective layer. Between front polarizer 12 and LC panel 14 is a one-quarter wave plate 202. A second one-quarter wave plate 204 is positioned between LC panel 14 and reflective polarizer 16. Note that the second one-quarter wave plate 204 is not required in all embodiments. For example, in embodiments in which the reflective polarizer 16 is a cholesteric reflective polarizer, one-quarter wave plate 204 would not be included. One-quarter wave plate 204 is shown dashed to represent its optional inclusion in such embodiments.

FIG. 2 illustrates display 200 in a LC vertical state with incident light rays for illustrative purposes. This is dark state reflective mode. Note that incident ray 250 is reflected as ray 252 back toward the observer. Ray 254 begins just like the absorbed reflected light 250 up to the point it enters the liquid crystal in transmissive area 222. Since the LC is in the vertical state and does not effect the light's polarization state, the light 254 continues in left hand circular (LHC) mode until it hits the second quarter wave film 204. At this point, it is converted to linear polarization, and passes freely through the reflective polarizer 16. The light is assumed to be lost in the backlight system. Note that adding a partially absorbing layer to the reflective polarizer will decrease the percentage of light that may re-enter the LCD panel.

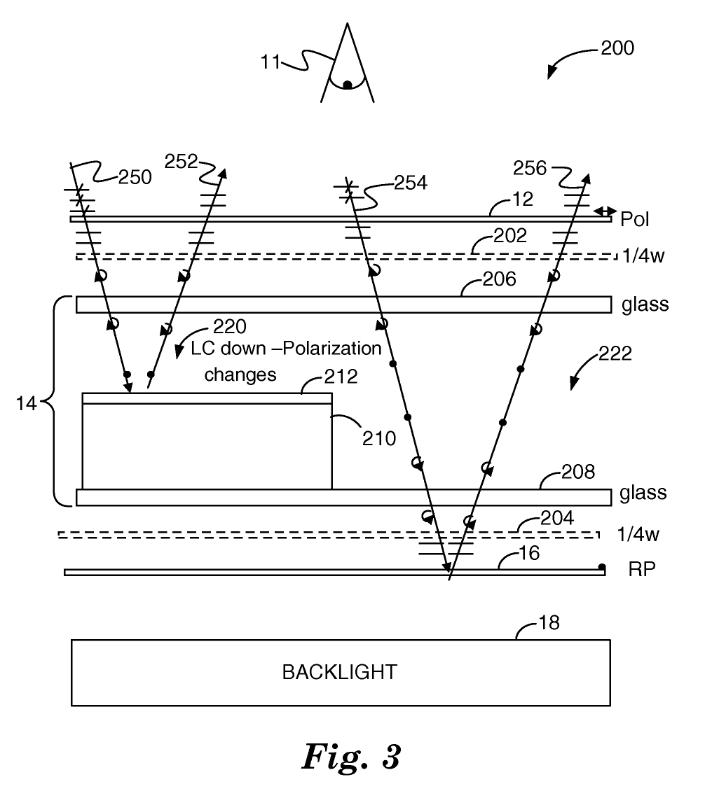

Referring now to FIG. 3, display 200 is shown in a LC down state, which in this particular display configuration is a bright state reflective mode. For the reflective mode with liquid crystal in the “down” (optically significant) state, the LHC light from incident ray 254 that enters the LC is converted to right hand circular (RHC) before exiting. It is then converted to linear polarization by the quarter wave plate 204, reflects from the reflective polarizer 16, and returns through the system in exactly the same fashion that it entered. This is represented by exiting light ray 256. The quarter-wave plate 204 converts ray 256 from linear to RHC, the LC converts ray 256 from RHC to LHC, the exit quarter wave plate 202 converts ray 256 from LHC to linear, and the light exits the system with very little loss.

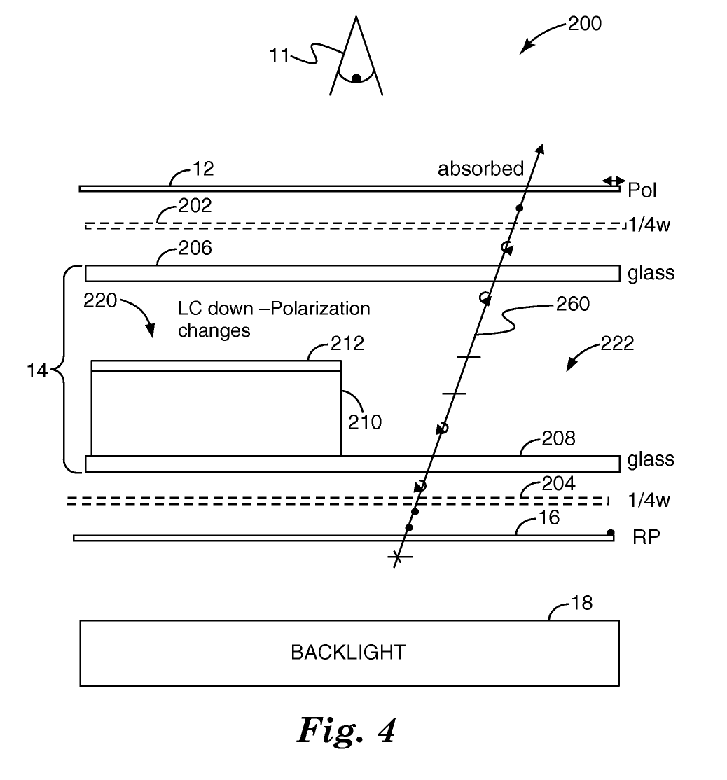

Referring to FIG. 4, shown is display 200 operating with backlighting in the dark state, transmissive mode. With the LC in the down state, light ray 260 transmitted by backlight 18 is converted to LHC light by the combination of reflective polarizer 16 and quarter-wave plate 204. The LC converts the light to RHC, which is then absorbed by the quarter wave plate 202 and front polarizer 12 combination at the top.

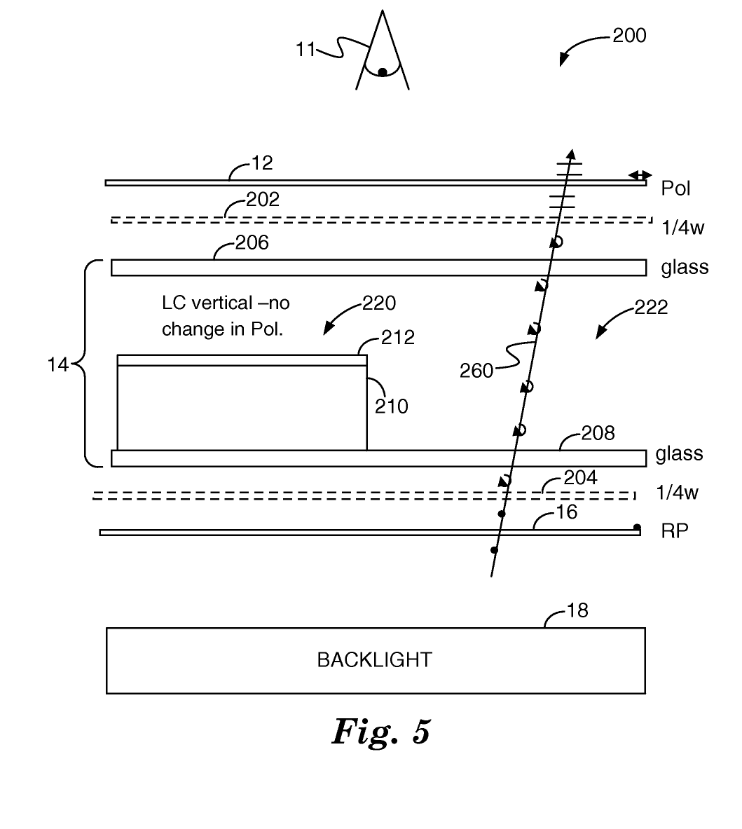

Referring now to FIG. 5, shown is display 200 operating with backlighting in the bright state transmissive mode. With the LC in the vertical state such that it does not modify transmitted light ray 260, the LHC light hits the quarter wave plate 202 and front polarizer 12 combination at the top, yielding a bright state in which light ray 260 is not absorbed. So, with the LC vertical, display 200 is in a bright state in transmission mode and a dark state in reflection mode. With the LC down, display 200 is in a dark state in transmission mode and a bright state in reflection mode. This yields an inverting display configuration. Very similar results can be obtained by removing the quarter wave films 202 and 204, and running the display in parallel-polarizer mode. The orientation of the reflective polarizer would be chosen such that the two reflected modes (aluminum and multilayer) worked together.

Unless otherwise indicated, all numbers expressing quantities, measurement of properties and so forth used in the specification and claims are to be understood as being modified in all instances by the term “about.” Accordingly, unless indicated to the contrary, the numerical parameters set forth in the specification and claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The foregoing description is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention. All patents and patent applications referred to herein are incorporated by reference in their entireties, except to the extent they are contradictory to the foregoing specification.

1. A transflective display having a reflective viewing mode and a transmissive viewing mode, the display comprising:
a liquid crystal (LC) panel having an array of partially reflective pixels, wherein reflective portions of the array of partially reflective pixels in the panel comprise reflective metal positioned on a viewer side of the LC panel to reflect light back toward the viewer; and
a reflective polarizer positioned behind the LC panel on a side of the LC panel opposite the viewer side, the reflective polarizer oriented to reflect ambient light back toward the viewer.

2. The transflective display of claim 1, and further comprising a backlight, wherein the reflective polarizer is positioned between the LC panel and the backlight.

3. The transflective display of claim 1, wherein in the LC panel, reflective portions of the array of partially reflective pixels further comprise metal positioned on the side of the LC panel opposite the viewer side.

4. The transflective display of claim 1, and further comprising a front absorbing polarizer positioned on the viewer side of the LC panel, wherein the reflective polarizer serves as a rear polarizer.

5. The transflective display of claim 4, wherein the reflective polarizer is a linear reflective polarizer.

6. The transflective polarizer of claim 5, wherein the linear reflective polarizer is a reflective display film (RDF).

7. The transflective polarizer of claim 5, wherein the linear reflective polarizer is a transflective display film (TDF).

8. The transflective polarizer of claim 5, and further comprising a first one-quarter wave plate positioned between the linear reflective polarizer and the LC panel and a second one-quarter wave plate positioned on the viewer side of the LC panel.

9. The transflective polarizer of claim 4, wherein the reflective polarizer is a wire grid reflective polarizer.

10. The transflective polarizer of claim 9, and further comprising a first one-quarter wave plate positioned between the wire grid reflective polarizer and the LC panel and a second one-quarter wave plate positioned on the viewer side of the LC panel.

11. The transflective display polarizer of claim 4, wherein the reflective polarizer is a cholesteric reflective polarizer.

12. A laminate optical film comprising:
a linear reflective polarizer;
a quarter wave film; and
a non-depolarizing diffuser.

13. A transflective display including the laminate optical film of claim 12.
